(19) United States
(12) Patent Application Publication
(10) Pub. No.: US 2002/0021272 A1
(43) Pub. Date: Feb. 21, 2002

(54) System and method for specifying video game data

(76) Inventor: Kai Zeh, Grossostheim (DE)

Correspondence Address: NIXON & VANDERHYE P.C., 8th Floor, 1100 North Glebe Road, Arlington, VA, 22201, US

(21) Appl. No.: 09/842,323

(22) Filed: Apr. 26, 2001

Related U.S. Application Data
(60) Provisional application No. 60/199,823, filed on Apr. 26, 2000.

(51) Int. Cl. G09G 3/36

(52) U.S. Cl. 345/87

(57) ABSTRACT

A system for providing video game specification data includes a display and a control circuit for causing the display to display an interactive form containing data entry fields for inputting game specification data that specifies characteristics of a video game developed for a particular game platform. This system may be part of a game submission system.

### RELATED APPLICATION

This application claims priority from provisional Application No. 60/199,823, filed Apr. 26, 2000, the contents of which are incorporated herein in their entirety.

### TECHNICAL FIELD

The present invention generally relates to a system and method for specifying video game data and, more particularly, to a computer-implemented system and method for specifying such data.

### BACKGROUND AND SUMMARY OF THE INVENTION

Video game developers and publishers develop games for execution on particular game machines (e.g., the N64® game console system and the GameBoy® portable game system, both available from Nintendo of America, Inc.). The game machine company tests video games developed by the developers/publishers to ensure that these video games work properly on the intended game machines. As part of the testing process, game developers/publishers typically submit to the game machine company information setting forth various specifications of the game. These specifications include the name of the game, the game machine with which the game is used, any game machine accessories that are used with the game and the like. The specifications also often include a checksum or CRC value that is obtained from the game program code. When the game is loaded onto the computer of the game machine company, the same checksum or CRC generating routine is executed. By comparing this checksum or CRC with the checksum or CRC set forth in the game specifications, data corruption can be detected. The game specifications are used to ensure that the game is properly tested on the appropriate machine, with the appropriate accessories, etc.

Generally, game specification data is submitted using printed forms that are manually filled out and then submitted with a “ROM image” of the game. Problems with this manner of providing game specification data include incompletely and incorrectly filled out forms, difficult to read forms, use of outdated forms, use of improper forms, and the like. These problems slow down the testing of the game by the game machine company and can result in delays in bringing the game to market.

Thus, it would be desirable to provide a system and a method that overcomes these problems. In accordance with one aspect of the present invention, a system for providing video game specification data includes a display and a control circuit for causing the display to display an interactive form containing data entry fields for inputting game specification data that specifies characteristics of a video game developed for a particular game platform. By providing the interactive form with required data entry fields and data validation, the system can ensure that all needed game specification data is provided. In addition, the forms can be printed out using a printer, thereby overcoming the problem of difficult to read forms. The system described herein may be implemented as part of an on-line system in which the data entry forms are Internet-accessible, thereby overcoming problems associated with the use of outdated forms and easing the process of game and game specification data submission.

In accordance with another aspect of the present invention, a game submission system for the electronic submission of video games and video game specification data is provided.

These and many other advantages of the present invention will be more completely understood and appreciated by careful study of the following more detailed description of illustrative embodiments of the invention taken in conjunction with the accompanying drawings.

### BRIEF DESCRIPTION OF THE DRAWINGS

FIG. 1 generally illustrates a computer system usable to implement the game data specification system and method described herein.

FIG. 2 shows one example of a game specification data entry form.

FIG. 3 shows another example of a game specification data entry form.

FIG. 4 is a form that may be provided to allow one-time entry of the game developer/publisher data.

FIG. 5 is a form that permits adjustment of the size of a ROM image.

FIG. 6 is a form that permits splitting or merging a ROM image.

FIG. 7 depicts a game submission system.

FIGS. 8A-8C show examples screens presented to a user of the game submission system of FIG. 7.

FIGS. 9A and 9B show data structures used in the game submission system of FIG. 7.

### DETAILED DESCRIPTION

The present invention provides a system including an application that, among other things, provides computerized data entry forms usable by game developers/publishers to provide game specification data to game machine companies or others that test the games. By providing forms having required fields and data validation, the application ensures that all needed game specification data is provided. In addition, the filled-out forms are printable, thereby overcoming problem of difficult to read forms. The system described herein may also be implemented as part of an on-line system in which up-to-date data entry forms for games for many different game machines are Internet-accessible, thereby overcoming problems associated with the use of outdated forms and even further simplifying the process of game and game specification data submission.

Those in the art will recognize that various tools are commercially available to develop an application that provides data entry forms and provides and/or uses programs, procedures and routines having the functionality described herein. The programs, procedures and routines include programs, procedures and routines for automatically filling-in data entry fields based on pre-entered data; validating data entry; designating certain fields as required fields; performing calculations of CRC's and checksums on ROM images; and manipulating ROM images (e.g., adjusting the ROM image size, merging and splitting ROM images, transmitting ROM images, etc.).

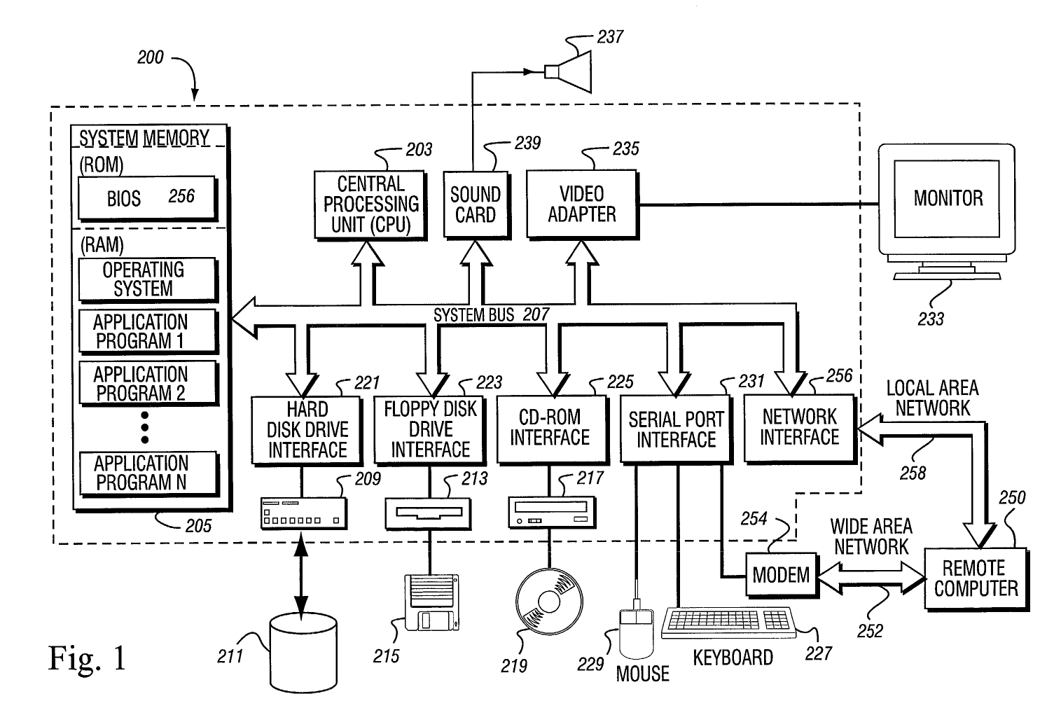

FIG. 1 generally illustrates a computer system 200 usable in the implementation of the systems and methods of the present invention. Computer system 200 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) and random access memory (RAM). A basic input/output system (BIOS) 256, containing the basic routines that help to transfer information between elements within computer system 201, such as during start-up, is stored in ROM 252. Computer system 200 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, programs, procedures, routines, data structures, program modules, and other data for computer system 200. In other configurations, other types of computer-readable media that can store data that is accessible by a computer (e.g., magnetic cassettes, flash memory cards, digital video disks, random access memories (RAMs), read only memories (ROMs) and the like) may also be used.

A number of program modules may be stored on hard disk 211, removable magnetic disk 215, optical disk 219 and/or ROM 252 and/or RAM 254 of system memory 205. Such program modules may include an operating system providing graphics and sound APIs, one or more application programs, other program modules, and program data. A user may enter commands and information into computer system 200 through input devices such as a keyboard 227 and a pointing device 229. Other input devices may include a microphone, joystick, game controller, satellite dish, scanner, or the like. These and other input devices are often connected to processing unit 203 through a serial port interface 231 that is coupled to system bus 207, but may be connected by other interfaces, such as a parallel port interface or a universal serial bus (USB). A monitor 233 or other type of display device is also connected to system bus 207 via an interface, such as a video adapter 235.

Computer system 200 may also include a modem 254 or other means for establishing communications over wide area network 252, such as the Internet. Modem 254, which may be internal or external, is connected to system bus 207 via serial port interface 231 (or some other interface). A network interface 256 may also be provided for allowing computer system 200 to communicate with a remote computing device 250 via a local area network 258 (or such communication may be via wide area network 252 or other communications path such as dial-up or other communications means). Computer system 200 typically includes other peripheral output devices, such as printers and other standard devices.

Computer system 200 is preferably equipped with an operating system supporting Internet communication protocols, such as Microsoft Windows 98 or Microsoft Windows NT and a browser, such as Microsoft Explorer or Netscape Navigator. Other types of computer systems are usable (e.g., a computer workstation, a local area network of computers, an interactive television, a personal digital assistant, an interactive wireless communications device or the like).

In accordance with one aspect of the present invention, data entry forms for games developed for particular game machines are provided. Among other things, these forms have required fields and data validation to ensure that all needed game specification data is provided. In addition, the filled-out forms are printable to enhance readability. The forms may also be provided “on-line” (Internet-accessible) so that up-to-date data entry forms for games for many different game machines are readily available. These on-line forms may be filled out and submitted on-line (with or without the game program) or may be printed out and otherwise submitted (e.g., regular mail, express mail, facsimile, etc.) to the game machine company or others that test the games.

It will be apparent that the game specification data will vary depending on the type of game machine for which the game is intended. In the following description, game specification data for games developed for the N64® game console and the GameBoy® Color portable game machine are described. Of course, the particular arrangement of fields, list boxes, combo boxes, etc. and the information requested via these fields, list boxes and combo boxes are provided by way of example, not limitation.

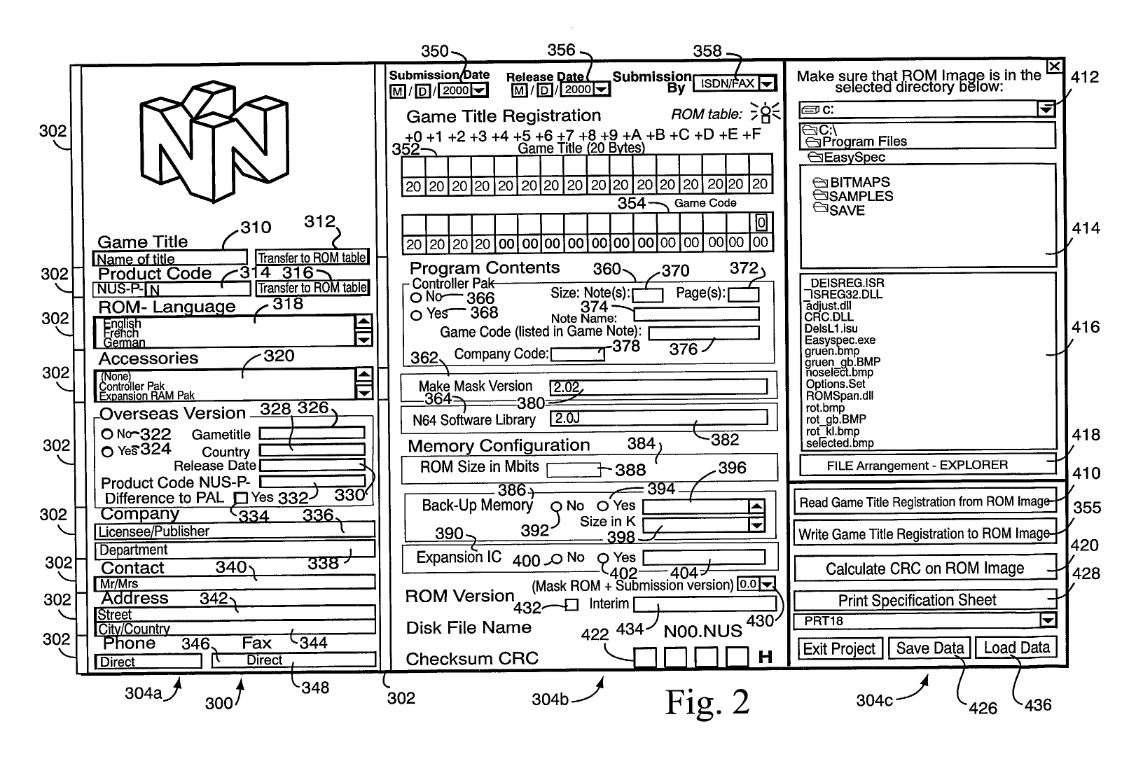

FIG. 2 shows an illustrative game specification data entry form 300 for specifying game data for games developed for the N64® game console system. Colored (e.g., red) bars are provided along the left side of each section or area of on-screen form 300 that requires a user to enter data. In the case of on-screen form 300, each of columns 304a and 304b include colored bars 302 along the left side thereof. When the user enters data, validation routines associated with the form determine whether the entered data is appropriate for that section of the form and confirm that the entered data is consistent with data entered in other fields. If so, the colored bar associated with that particular section is eliminated. Alternatively, the color of the bar may be changed to a different color (e.g., green) to indicate that the entered data is appropriate for that section of the form and confirm that the entered data is consistent with data entered in other fields. In this way, a user is quickly and easily informed as to those sections of the form that have not been filled out or have been improperly filled out. Pop-up dialog boxes may be used to inform the user of a particular problem with entered data or of the failure to enter certain required data. For example, a pop-up dialog box may be displayed if a user attempts to print out or save a form and data is missing from one or more required fields. The dialog box may, for example, inform the user as to what data is missing and, upon the closing of the dialog box, focus may be given to the field, list box, combo box corresponding to the missing data.

A Game Title form section includes a field 310 for entering the title of the new game (e.g., RED BROWN FOX). If desired, the developer/publisher may utilize a game naming convention agreed upon with the game machine company, although this is not required. Within the Game Title form section is a button 312 labeled “Transfer to ROM table”. Pressing button 312 automatically fills the title entered in field 310 into a game title entry 352 of a Game Title Registration form section in column 304b of form 300. This automatic entry into game title entry 352 reduces the possibility of data entry errors by the user.

A Product Code form section includes a field 314 for entering a game code (e.g., NBQE) for the new game. The game code may, for example, be supplied (e.g., via facsimile or e-mail) from the game machine company to the game developer/publisher upon request, typically when the game developer/publisher is nearing completion of the game. Together with the prefix “NUS-P”, the contents of field 314 define a product code. Within the Product Code form section is a button 316 labeled “Transfer to ROM table”. Pressing button 316 automatically fills the game code entered in field 314 into a game code entry 354 of the Game Title Registration form section. Again, this automatic entry into game code entry 354 reduces the possibility of data entry errors by the user.

A ROM-Language form section includes a list box 318 for selecting the ROM language. List box 318 contains a list of possible ROM languages (e.g., English, French, German, etc.) for the new game. ROM language refers to languages in which the consumer may view the game. Some games provide several languages to appeal to a variety of markets.

An Accessories form section includes a list box 320 for selecting the game accessories that are used with the game. List box 320 contains a list of all possible game accessories (e.g., none, Controller Pak, expansion RAM pack, GB (GameBoy) pack, mouse, Rumble Pak, Voice Recognition System etc.) that are usable with games developed for the relevant game system (in this case the N64® game console system). The user is able to select none, one, or more than one of the accessories identified in list box 320.

An Overseas Version form section includes NO/YES radio buttons 322, 324 for indicating whether there is an overseas (i.e., non-North American) version(s) of the game. In many cases, a game will have been released in one or two other markets or countries (e.g., Japan and/or Europe) prior to its release in the North American market. The Overseas Version form section includes a field 326 for entering the overseas game title, a field 328 for entering the overseas country, a field 330 for entering the release date of the overseas game, a field 332 for entering the game code of the overseas game, and a checkbox 334 for designating if there is “Difference to PAL”. “PAL” refers to the European market while NTSC refers to the North American market. In some cases, the game codes of the overseas and North American versions may differ only in the last characters thereof, although there is no certainly limitation in this regard inasmuch as completely different game codes may also be used. A user designates that there is an overseas version of the new game by selecting YES radio button 324. In this case, the user is then able to enter the overseas game information via fields 326, 328, 330 and 332 and checkbox 334. A user designates that there is no overseas version of the new game by selecting NO radio button 322. In this case, fields 326, 328, 330 and 332 and checkbox 334 are “grayed out” and no data entry is permitted.

A Company form section includes a field 336 for entering the name of the developer/publisher submitting the game. Also within the Company form section is a field 338 for inputting a particular department (if any) of the developer/publisher that is submitting the game.

A Contact form section includes a field 340 for inputting the name of a contact person at the developer/publisher identified in field 336. An Address form section includes fields 342 and 344 for entering address information (e.g., street, city, state, country, zip (postal) code) for the licensee/publisher identified in field 336. A Phone/Fax form section includes fields 346 and 348 for entering the telephone and facsimile numbers, respectively, of the licensee/publisher identified in field 336.

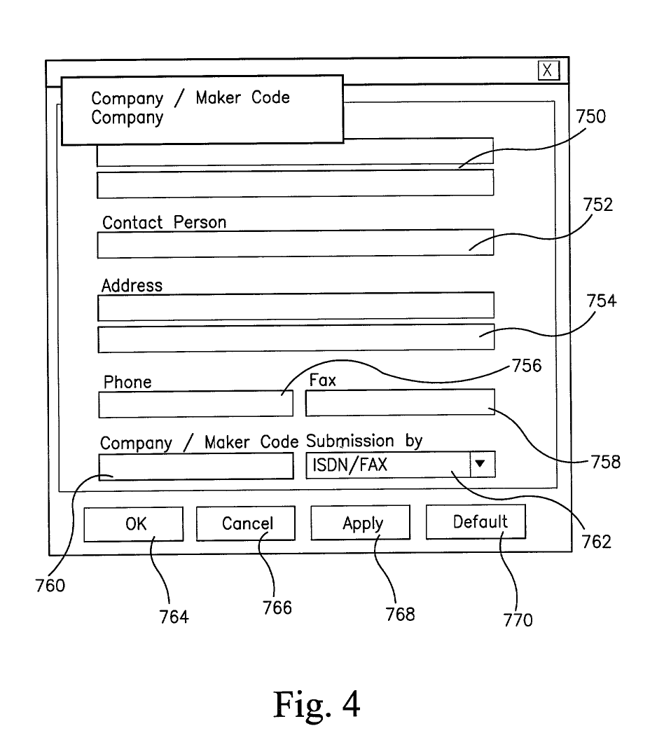

As will be explained below with reference to FIG. 4, the contents of the Company form section, the Contact form section, the Address form section, and the Phone/Fax form section may be automatically filled in when form 300 is first opened using pre-entered data. In this way, the data for these form sections need not be entered each time a new form is filled out.

A Submission/Release form section includes fields 350 for entering the date of the submission of the new game to the game machine company and fields 356 for entering the release date of the new game. The Submission/Release form section also includes a combo box 358. The user selects the manner in which the game specification data will be submitted to the game machine company from the choices in combo box 358 (e.g., ISDN/Fax, Mail, Hand, Mail+ISDN/Fax). As will also be explained below with reference to FIG. 4, the submission type may also be automatically filled in when form 300 is first opened using pre-entered data.

As mentioned above, the Game Title Registration form section includes a game title entry 352 and a game code entry 354. As further mentioned above, these entries are generated based on the information entered in field 310 and field 314. The on-screen form is preferably provided with validation routines that warn the user of inconsistencies between the information entered in field 310 and the game title entry 352 and between the information entered in field 314 and the game code entry 354. Pressing “Write Game Title Registration to ROM Image” button 355 writes the information in the Game Title Registration form section (i.e., the game title entry 352 and game code entry 354) to predetermined memory locations of the ROM image of the game.

A Program Contents form section includes a Controller Pak area 360, a MakeMask Version area 362, and an N64 Software Library area 364. Controller Pak area 360 includes NO/YES radio buttons 366, 368 for designating whether a controller pak is used with the new game. A controller pak is a removable memory cartridge that plugs into the game controller of a Nintendo 64 game system and is used to store game configuration data outside the game cartridge. Controller Pak area 360 includes a field 370 for designating the maximum quantity of used notes, a field 372 for designating the maximum quantity of used pages, a field 374 for designating the note name, a field 376 for designating the game code, and a field 378 for designating the company code (maker code) identified on the controller pak note. Controller Pak note refers to one of up to sixteen notes that can be saved to an individual Controller Pak. Essentially, the Controller Pak is a filing cabinet that can contain up to sixteen folders. The maximum number of pages allowed in the cabinet is 123. If each folder contains 1 page, then the cabinet is still full if all 16 folders are full. The same applies if one folder contains 123 pages. Although the remaining 15 folders are not used, the cabinet is still full. It is necessary to know how many pages are used by each note to determine if the game should allow the user to save to a Controller Pak or not. For example, if the note for a game requires 42 pages (as dictated by the developer/publisher), then the game machine company may test for proper messaging if the Controller Pak being used does not have sufficient pages available. In some cases, a single game may have different save options, thereby requiring more than one note. For example, a baseball game might save Options, Progress in a season mode, and playoff mode. The game could require three notes in that case, each with a different number of pages. The Note Name is set by the developer/publisher to indicate which notes are for its game. A Controller Pak may contain notes from several games (space permitting). A user designates the use of a Controller Pak by selecting YES radio button 368. In this case, the user is then able to enter the controller pack information via fields 370, 372, 374, 376 and 378. A user designates that the game makes no use of a controller pack by selecting NO radio button 366. In this case, fields 370, 372, 374, 376 and 378 are “grayed out” and no data entry is permitted.

The MakeMask Version area 362 includes a field 380 for designating the MakeMask version and the N64 Software Library area 364 includes a field 382 for designating the N64 software library version. The MakeMask version is a program that changes the created file (from a personal computer or an SGI workstation) to data for use in mass production. This program is typically provided by the game company to all developers/publishers. The Software Library is a collection of predefined routines provided to game developers/publishers by the game machine company to help facilitate the development of software for the machines of the game company.

A Memory Configuration form section includes a ROM Size area 384, a Back-up Memory area 386, and an Expansion IC area 390. ROM Size area 384 includes a field 388 for designating the ROM size in Mbits. Back-up Memory area 386 includes NO/YES radio buttons 392/394 for designating whether the new game uses back-up memory. Back-up Memory area 386 also includes a combo box 396 for selecting the type of back-up memory (e.g., EEPROM, Flash, SRAM, etc.) and a combo box 398 for selecting the size of the back-up memory to be used. The user designates that the new game will make use of a back-up memory by selecting YES radio button 394. In this case, the user is able to enter information in combo boxes 396 and 398. The user designates that the new game will not make use of a back-up memory by selecting NO radio button 392. In this case, combo boxes 396 and 398 are “grayed out” and no data entry is permitted.

An Expansion IC form section 390 includes NO/YES radio buttons 400/402 for designating whether the new game uses an expansion IC. An example of an expansion IC is the FX chip available for the Super Nintendo Entertainment System. This IC allows additional programming to improve the graphic quality of games. The Expansion IC form section also includes a field 404 for identifying the type of expansion IC. The user designates that the new game will make use of an expansion IC by selecting YES radio button 402. In this case, the user is able to enter IC type information in field 404. The user designates that the new game will not make use of an expansion IC by selecting NO radio button 400. In this case, IC type field 404 is “grayed out” and no data entry is permitted.

Pressing “Read Game Title Registration from ROM Image” button 410 reads information from predetermined memory locations of the ROM image of the game and displays the information in game title entry 352 and game code entry 354, as well as in field 310 and field 314. The user may search the computer memory to locate the ROM image of the game using combo box 412 to select a disk drive (e.g., a:, c:, d:, etc.), then using display region 414 to select a directory of the drive selected in combo box 412, and then using display region 416 to select a file contained in the directory selected in display region 414. “File Arrangement—EXPLORER” button 418 allows the user to look for a ROM image using functionality provided with the Windows® 98 operating system.

Some sections of on-screen form 300 are updated automatically based on data entries in other sections. For example, when “Controller Pak” is selected in the Accessories section 320, the “Yes” check box in the Controller Pak section 360 is automatically checked.

Once on-screen form 300 is completed, the user presses “Calculate CRC on ROM Image” button 420 in column 304c. This automatically fills in the necessary CRC information in fields 422. The application includes a stored procedure that automatically calculates a CRC. A CRC is a value derived from, and stored or transmitted with, a block of data in order to detect corruption. Errors can be detected by recalculating the CRC and comparing the recalculated CRC to the value originally transmitted.

The ROM version selected at combo box 430 is an indicator of which revision of a game is being submitted to the game company. The version number is indicated by a value such as 0.0 or 1.a. Both values begin at 0 and progress in increments of one for each resubmission of the game. The first number of the value indicates the Mask ROM version (or production version). In some cases, a game will be manufactured and released. During subsequent testing, a bug may be found that the developer, publisher and/or game company determines should be fixed. The subsequent production run would be version 1.x, 2.x, etc.

The second value indicates the submission version. The first version submitted to the game company is called version 0.0. If the game does not meet the game machine company's specifications, then it is necessary for the developer/publisher to correct and resubmit the same. The second submission would be 0.1.

An Interim ROM checkbox 432 and corresponding field 434 may be used to designate ROM version information for game submissions that are not being officially submitted for testing by the game machine company. Rather the game is being submitted for evaluation of its overall quality—not adherence to guidelines—by, for example, a “club” of users of games of a particular genre (e.g., Pokemon® games).

The user can save the form by pressing button 426 and print the form by pressing button 428. This allows developers/publishers to fax and/or e-mail the game data specification forms to the game marketer as an original rather than a copy. This also eliminates hand-written forms that are often illegible after faxing and copying. In an on-line implementation, form 300 may be provided with a “Submit” button (not shown) for submitting the completed form over the Internet. An option may also be provided to submit the game program itself over the Internet. Button 436 allows a saved version of a form to be restored (or “loaded”). For example, if a developer/publisher sends a saved file of form 300 to the game machine company, the game machine company can load the file and view/print the form information as needed.

If the user attempts to save, print or exit the form while improperly filled-out sections are present, the user receives an error message specifying the error (e.g., by a pop-up dialog box) and, if provided, a help message suggesting how the error may be corrected. This ensures that the form is properly filled out.

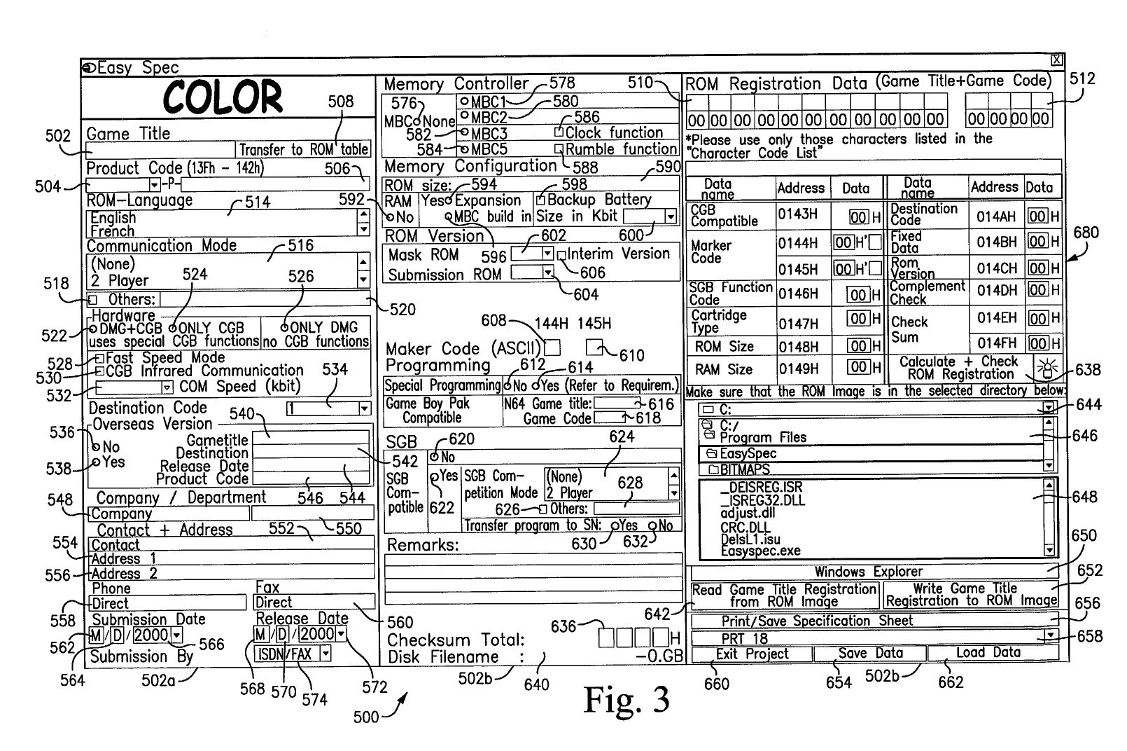

FIG. 3 shows another example of a game specification data entry form. Game specification entry form 500 is usable in connection with games developed for use with the GameBoy® Color portable game system available from Nintendo of America, Inc. Details of the GameBoy® Color portable game machine may be found in U.S. patent application Ser. Nos. 09/321,210 and 09/454,607, the contents of which are incorporated herein in their entirety. Here again, of course, the particular arrangement of fields, list boxes, combo boxes, etc. shown in FIG. 3 is provided by way of example, not limitation.

A Game Title form section includes a field 502 for entering the title of the new game (e.g., NOE PT DEMO). A Product Code form section includes a combo box 504 and a field 506 for entering a product code (e.g., DMG-P-DEMO) for the new game. In the illustrative form shown in FIG. 3, combo box 504 allows a user to select from among a plurality of predetermined designations that identify the product for which the game was developed (e.g, DMG (dot matrix game machine), CGB (GameBoy® Color game machine), etc.) and field 506 allows entry of a game code (e.g., DEMO). The code is typically assigned by the game machine company and provided to the game publisher/developer upon request. In the example shown in FIG. 3, the last four characters of the code are variable. The first character may, for example, indicate the system and/or features on the production ROM. The second and third characters may be assigned based on the game name. The fourth character may indicate the market in which the game is to be released (e.g., E- North American market; P-European market; and J-Japanese market).

Within the Game Title form section is a button 508 labeled “Transfer to ROM table”. Pressing button 508 automatically fills the title entered in field 502 and the game code entered in field 506 into a game title entry 510 and a game code entry 512 of a ROM Registration form section in column 502c of the form. This automatic entry into game title entry 510 and game code entry 512 reduces the possibility of data entry errors by the user.

A ROM-Language form section includes a list box 514 for selecting the ROM language. List box 514 contains a list of possible ROM languages (e.g., English, French, German, Japanese, etc.) for the new game.

A Communication Mode form section includes a list box 516 for selecting the communication mode for the new game. List box 516 contains a list of possible communication modes (e.g., none, two player, four player, pocket printer, etc.) for the new game. The Communication Mode form section includes a check box 518 and a field 520 that permit a user to enter a communication mode not contained in list box 516.

A Hardware form section includes radio buttons 522, 524, and 526 for designating the hardware for which the new game was developed (e.g., DMG and CGB, CGB Only, or DMG Only). Also within the Hardware form section is a checkbox 528 for indicating whether the game uses a fast speed mode of operation; a checkbox 530 for indicating whether the game utilizes the infrared communication capabilities of the game machine; and a combo box 532 for indicating the speed (in kilobits) of the COM (serial) port. The “fast” speed mode of operation refers to CPU speed. In many CGB games, the game may use a higher processing speed to provide better overall game quality. In other games, the fast speed is not used to maintain backwards compatability with older DMG machines.

A Destination Code form section includes a combo box 534 for designating a code indicative of the destination of the new game (e.g., 0—Japan, 1—Others).

An Overseas Version form section includes NO/YES radio buttons 536, 538 for indicating whether there is an overseas (i.e., non-North American) version(s) of the new game. The Overseas Version form section includes a field 540 for entering the overseas game title, a field 542 for entering the overseas destination, a field 544 for entering the release date of the overseas game, and a field 546 for entering the product code of the overseas game. The game company may utilize a game code designation process in which the last character will typically be the only difference between the game codes for different markets. A user designates that there is an overseas version of the new game by selecting YES radio button 538. In this case, the user is then able to enter the overseas game information via fields 540, 542, 544 and 546. A user designates that there is no overseas version of the new game by selecting NO radio button 536. In this case, fields 540, 542, 544 and 546 are “grayed out” and no data entry is permitted.

A Company/Department form section includes a field 548 for entering the name of the developer/publisher submitting the new game and a field 550 for inputting a particular department (if any) of the developer/publisher that is submitting the new game.

A Contact+Address form section includes a field 552 for inputting the name of a contact person at the developer/publisher identified in field 548 and fields 554 and 556 for entering address information (e.g., street, city, state, country, zip (postal) code) for the developer/publisher identified in field 548. A Phone form section includes a field 558 for entering the telephone number of the developer/publisher identified in field 548 and a Fax form section includes a field 560 for entering the facsimile number of the developer/publisher identified in field 548.

As will be explained below with reference to FIG. 4, the contents of the Company/Department form section, the Contact+Address form section, the Phone form section, and the Fax form section may be automatically filled in when form 500 is first opened using pre-entered data. In this way, the data for these form sections need not be entered each time a new form is filled out.

A Submission Date form section includes fields 562, 564, and combo box 566 for respectively entering the month, date, and year of the submission of the new game to the game marketer. A Release Date form section includes fields 568, 570 and combo box 572 for respectively entering the month, date and year of the release of the new game. A Submission By form section includes a combo box 574 for selecting the manner in which the game specification data will be submitted to the game marketer (e.g., ISDN/Fax, Mail, Hand, Mail+ISDN/Fax). The Submission By form section may be automatically filled in using pre-entered data as will be explained below with reference to FIG. 4.

A Memory Controller form section includes radio buttons 576, 578, 580, 582, and 584 for designating whether a memory bank controller is utilized with the game and, if so, the particular type of memory bank controller utilized (i.e., MBC1, MBC2, MBC3 or MBC5). A memory bank controller is a chip included in a game cartridge which allows the CPU to address memory beyond its normal reach. By dividing the memory into banks and exchanging which banks are visible, a large amount of memory can be made addressable. If MBC3 is designated by selecting radio button 582, check box 586 may be checked to indicate that the clock function of MBC3 is utilized. If a memory controller other than MBC3 is designated, check box 586 is grayed out. If MBC5 is designated by selecting radio button 584, check box 588 may be checked to indicate that the rumble feature of MBC5 is utilized. If a memory controller other than MBC5 is designated, check box 588 is grayed out.

A Memory Configuration form section includes a field 590 for the size of the ROM which may, for example, be determined by a stored procedure of the application. The Memory Configuration form section also includes radio buttons 592, 594 and 596 for designating whether extended RAM is used with the game. A user may designate that no extended RAM is used with the game by selecting radio button 592. A user may designate that expansion RAM is used with the game by selecting radio button 594 or, if memory controller MBC2 is selected in the Memory Controller form section, that built-in RAM is used with the game by selecting radio button 596. If either type of extended RAM is used, a check box 598 may be used to designate that a back-up battery is used. If the expansion type of extended RAM is used, combo box 600 may be used to designate the size of the extended RAM (e.g., 64, 256, 1024 kilobits).

A ROM Version form section includes a combo box 602 for designating the Mask ROM version (e.g. 1, 2, 3, . . . ) and a combo box 604 for designating the Submission ROM version (e.g., 1, 2, 3, . . . ). A check box 606 allows the user to designate that the mask ROM is an interim version. An interim version refers to a game that is not officially being submitted for testing to the game company. Instead, the game is being submitted for evaluation of its quality—not its adherence to the game machine company's guidelines.

A Maker Code form section includes fields 608 and 610 for entering an ASCII maker code.

A Programming form section includes radio buttons 612 and 614 for specifying whether the game includes special programming. Special Programming refers to any programming that allows the game to use special features on the Super GameBoy® (SGB) product. Super GameBoy® is a cartridge that plugs into the SNES, and accepts GameBoy® cartridges. The special programming can be a screen saver or “frame” programmed specifically for this game. The SGB is pre-programmed with several screen saves and frames that can be used by all games. However, some games utilize special programming to make these features within the context of the game. The Programming form section also contains fields 616 and 618 for designating whether the game is compatible with a GameBoy® Pack that permits a transfer of data to a game played on an N64® game console. Field 616 is for entering the name of the corresponding N64® game and field 618 is for entering the game code of the corresponding N64® game.

A Super GameBoy form section includes NO/YES radio buttons 620 and 622 for designating whether the new game is compatible with the Super GameBoy® product. The user may designate that the game is not compatible with SGB by selecting radio button 620 and the user may designate that the game is compatible with SGB by selecting radio button 622. The user may specify the SGB competition mode (e.g., none, 2 player, 4 player) using list box 624. If the SGB competition mode is not contained in the list of list box 624, the user may “check” check box 626 and enter the competition mode in field 628. The user may also indicate whether the program is transferred to SNES system using YES/NO radio buttons 630 and 632.

A Remarks form section permits entry of any remarks that the game developer/publisher might wish to submit along with the game.

A Checksum Total form section 636 displays a checksum that is calculated based on the game data. Calculation of the checksum is initiated by pressing button 638 labeled “Calculate+Check ROM Registration”. Errors can be detected by later recalculating this checksum and comparing the recalculated checksum with the originally calculated checksum.

Disk filename section 640 displays the file name of the ROM image for which information is being entered.

Pressing the button 642 that is labeled “Read Game Title Registration from ROM Image” causes information to be read from predetermined memory locations of the ROM image of the game and displays the information in game title entry 510 and game code entry 512, as well as in the Data form section 680, in fields 502 and 506, and in combo box 504. The user may search the computer memory to locate the ROM image of the game using combo box 644 to select a disk drive (e.g., a:, c:, d:, etc.), then using display region 646 to select a directory of the drive selected in combo box 644, and then using display region 648 to select a file contained in the directory selected in display region 646. The button 650 that is labeled “File Arrangement—EXPLORER” allows the user to look for a ROM image using functionality provided with the Windows® 98 operating system.

Pressing the button 652 that is labeled “Write Game Title Registration to ROM Image” writes the data in the ROM Registration Data section to predetermined memory locations of the ROM image for the game.

The user can save the form by pressing button 654 and print/save the form by pressing button 656. List box 658 may be used to select a particular printer to which the print out is to be directed. This allows developers to fax and/or e-mail the game data specification forms to the game marketer as an original rather than a copy. This also eliminates hand-written forms that are often illegible after faxing and copying.

The form may be exited by pressing button 660 labeled “Exit Project”. The “Load Data” button 662 allows a saved version of a form to be restored. For example, if a developer/publisher sends the game company a saved file of a form, the “Load Data” button may be utilized to load the file and view/print the information as needed.

If the user attempts to save, print or exit the form while improperly filled-out sections are present, the user receives an error message specifying the error (e.g., by a pop-up dialog box) and, if desired, a help message suggesting how the error may be corrected. This ensures that the form is properly filled out.

FIG. 4 is a form that may be provided to allow one-time entry of the developer/publisher data including company name at 750, contact person at 752, address at 754, phone at 756, fax at 758, company/maker code at 760 and the type of submission at 762. Filling out this form causes the entered data to be saved by the game specification application. Then, when the user uses the application to specify game data using, for example, the forms shown in FIGS. 2 and 3, the fields on these forms that correspond to the information entered in the form of FIG. 4 are automatically filled in. Buttons 764, 766, 768 and 770 may be pressed to exit the form, to cancel any changes made to the fields of the form, to apply any changes made to the fields of the form, or to set default values of the fields of the form.

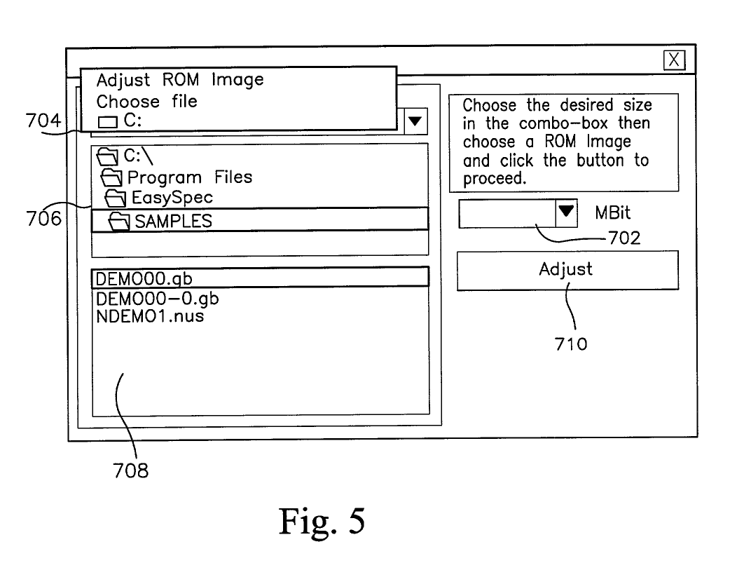

FIG. 5 is a form that is usable to adjust the size of a ROM image. The adjustment utilizes a padding program designed to make the file size an appropriate size to match the ROM board configuration. For example, a game's code may be 88 Mb while the closest ROM size is 96 Mb. The padding program pads the file to 96 Mb to make it the appropriate size for mass production. The padding program may be provided to developers/publishers as part of a Software Development kit provided by the game machine company. Referring to FIG. 5, the user enters the desired ROM image size (Mbits) in combo box 702 and then chooses a ROM image via a drive selection made in combo box 704, a directory selection made from the directory structure shown in box 706 and a file selection made from the file list shown in box 708. Clicking button 710 labeled “Adjust” causes execution of the padding program to adjust the ROM size to the size entered in combo box 702.

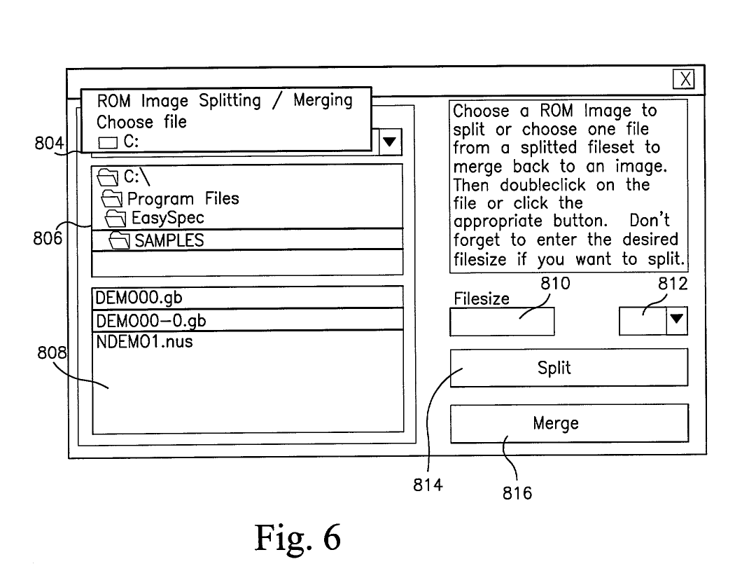

FIG. 6 is a form that is usable to split or merge a ROM image. In some cases, developers/publishers submit games on floppy disks. In this case, it is necessary to split the file to a size that can be accommodated on floppy disks. Referring to FIG. 6, the user chooses a ROM image to split or one file from a split file set to merge back to an image via a drive selection made in combo box 804, a directory selection made from the directory structure shown in box 806 and a file selection made from the file list shown in box 808. The desired file size is entered via field 810 and combo box 812. The user then clicks on the appropriate one of buttons 814 labeled “Split” and 816 labeled “Merge”. Clicking on button 810 causes execution of a program that splits the selected ROM image and clicking on button 812 causes execution of a stored procedure that merges the selected file back to a ROM image.

The process of using the game data specification system of the present invention is as follows. The software is distributed to developers/publishers using disks (magnetic or optical) or a connection via the Internet, for example. The application is then loaded onto the developer's/publisher's computer and the developer/publisher uses the application to fill out the game data specification forms that are appropriate for the game being submitted. The filled out form, along with the game software, is then submitted to the game machine company. The game machine company then runs the same CRC/checksum and ROM registration data checks on the submitted software to ensure the accuracy of the data. If the data is accurate, the game machine company begins testing of the game.

Of course, game machine companies will develop other forms specific to the particular games that are developed by developers/publishers.

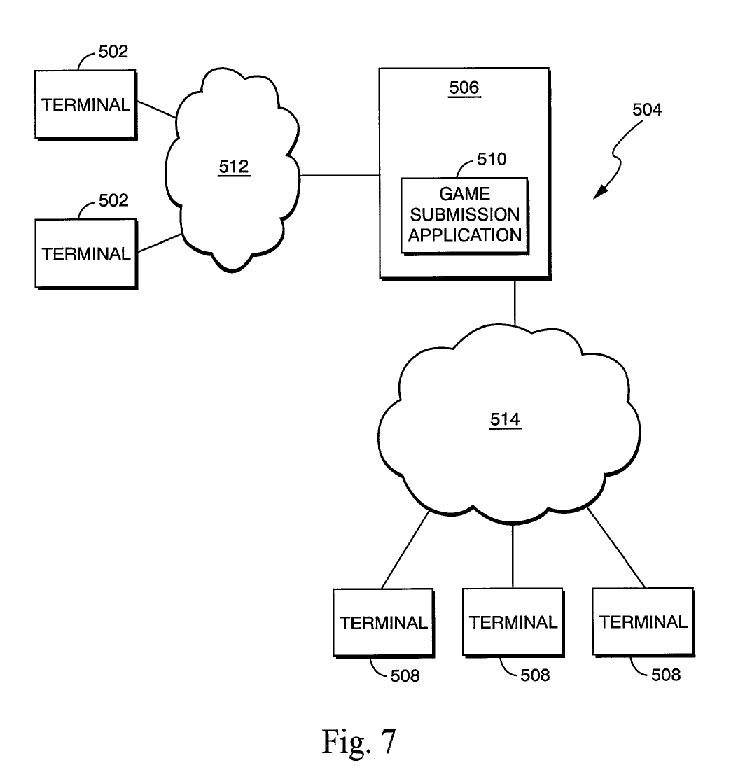

The game specification system described above may be provided as part of a game submission system that will now be described. FIG. 7 depicts a game submission system 500 in which game developers use respective (first) terminals 502 to electronically submit games and game specification data to a game submission computer system 504. Terminals 502 may be the computer systems used by the game developers to develop the games or may simply be terminals onto which the developed games are loaded (or to which the developed games are accessible) for submission. Game submission computer system 504 includes a server system 506 connected to a plurality of (second) terminals 508. Terminals 508 may be computer systems used by game reviewers and testers. Server system 506 may comprise one or more server computers (e.g., a primary server and a back-up server for redundancy in the event the primary server is “off-line” due to a failure, maintenance, etc.) having processing circuitry for executing a game submission application 510 to be described below. The communication network 512 between terminals 502 and server system 506 and the communication network 514 between server system 506 and terminals 508 may be any conventional wired or wireless networks. In one illustrative, non-limiting implementation, communication network 512 is a wide-area network (WAN) such as the Internet and communication network 514 is a local area network (LAN). Terminals 502, server system 506 and computer terminals 508 may all be configured with processing circuitry, memory, etc. along the lines shown in FIG. 1 and are all provided with appropriate communication circuitry such as modems, network interface circuitry and the like.

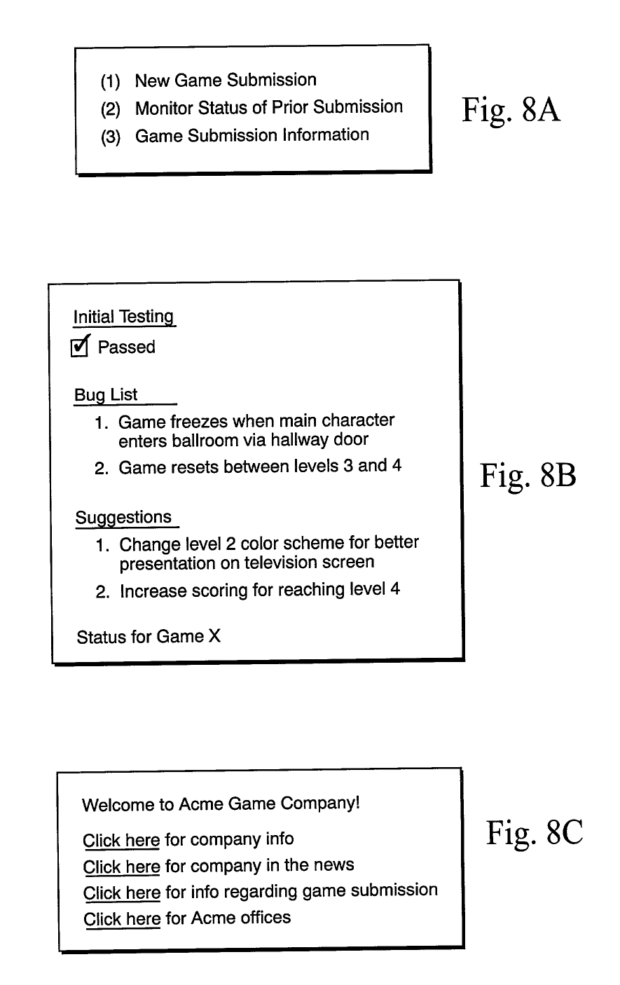

Terminals 502 connect to server system 506 in a manner appropriate for the nature of communication network 512. For example, if the communication network is the Internet, terminals 502 may run a browser application (e.g., Microsoft Internet Explorer) for connecting to server system 506 upon entry of an appropriate URL. Upon successful connection (and possibly the entry of an appropriate password), the game submission application 510 generates a menu of selectable options. As shown in FIG. 8, an example menu 520 includes selectable options for (1) New Game Submission; (2) Monitor Status of Prior Game Submission; and (3) Game Submission Information. If menu option (1) is selected, the game submission application 510 generates one or more display screens usable by operators of terminals 502 to submit a new game for review and testing by the operator of the game submission computer system 504. These display screens may be of the kind described above with reference to FIGS. 2-4. If menu option (2) is selected, the game submission application 510 generates one or more display screens that provide game submission status information (e.g., estimated time of review completion, results of review, problems encountered during testing of submitted game, suggested changes to game, etc.) regarding a previously submitted game. If menu option (3) is selected, the game submission application 510 generates one or more display screens providing general information regarding game submission, the operator of the game submission computer system, contact information, etc.

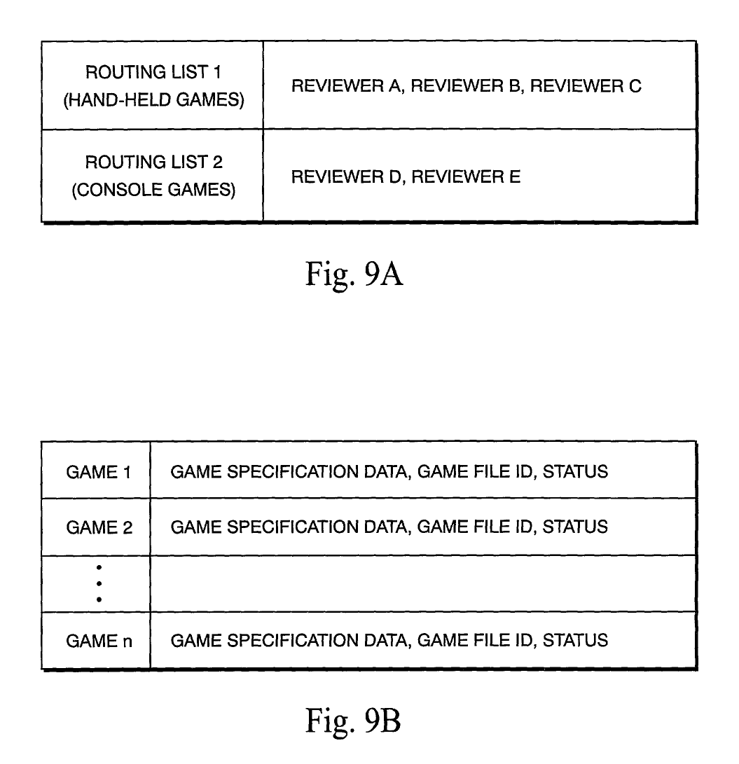

The memory of system server 506 stores the game submission application 510, game submissions and associated data, and data used by the game submission application. This data may include routing lists used to automatically route particular game submissions or particular types of game submissions (and/or notifications concerning the same) to particular game reviewers or testers using terminals 508. For example, with reference to FIG. 9A, a first routing list of reviewers or testers (Routing List 1) may be created for hand-held game submissions and a second routing list of reviewers or testers (Routing List 2) may be created for console game submissions. For each reviewer or tester, the routing list may contain an identifier (e.g., name or handle), routing information (e.g., an e-mail address, a network address), and routing type information (e.g., whether the reviewer or tester is to receive the game and the game specification data or simply a notification as to the submission of the game and the game specification data). It will of course be appreciated that each component of the routing list may in fact be composed of one or more data fields. For example, “name” may be composed of a first name field, a last name field, a middle initial field, etc. This automatic routing promptly notifies the appropriate personnel that a game submission has been received so that the game review and testing process can begin.

The memory of system server 506 also includes a game data structure as shown in FIG. 9B. This data structure includes, for each game, the game specification data, a game file identifier or pointer, and game submission status information. As in the case of the data structure shown in FIG. 9A, each component of the game data structure may be composed of one or more data fields. For example, the game specification data may include fields for the data entered using the screens of FIGS. 2-4 and the game submission status information may include fields for the estimated time of review completion, results of review, problems with submitted game, and suggested changes to game.

The game submission status information is generated as the game reviewers and testers review and test the submitted games. For example, an initial determination may be made by one of the testers at one of the terminals 508 as to whether the submitted game is operable for reviewing and testing purposes. Other testers may create “bug lists” of, for example, game program bugs that cause the game to lock up or to otherwise become unplayable. Reviewers may create a “suggested improvement list” for improving the game play. These suggestions may range from changing which game controller buttons are used for game activities, changing the graphics, changing scoring, improving game play, etc. The results of these determinations may be written to the data structure of FIG. 9B in the memory of system server 506. The game submission application uses this data to generate a status screen like that in FIG. 8B to provide an indication of the status of the game reviewing and testing to the game submitter.

FIG. 8C is a screen that may be used to provide game submission information if option (3) is selected from the screen of FIG. 8A.

It may be desirable to control access to the various data stored in the memory of system server 506. For example, certain submission status information may be for the “internal use only” of the operator of the game submission computer system. Thus, the game submission application 510 may be configured to prevent such information from being provided to terminals 502.

Although not described in detail above, it will be appreciated that the game submission system 500 may be provided with appropriate security features including passwords, firewalls, encryption/decryption and the like. For example, access to game submission application running on server system 506 may require entry of a password and some or all of the communication between server 506 and computer terminals 508 and server 506 and terminals 502 may be encrypted.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A system for providing video game specification data, comprising:
a display;
a control circuit for causing said display to display an interactive form containing data entry fields for inputting game specification data that specifies characteristics of a video game developed for a particular game platform.

2. The system according to claim 1, wherein one or more of the data entry fields have data validation rules associated therewith.

3. The system according to claim 1, further comprising:
a procedure that is executable to generate a CRC from a ROM image of the video game.

4. The system according to claim 1, further comprising:
a procedure that is executable to split a ROM image of the video game.

5. The system according to claim 1, further comprising:
a procedure that is executable to merge a file with a ROM image of the video game.

6. The system according to claim 1, further comprising:
a procedure that is executable to adjust the size of a ROM image of the video game.

7. A method for providing video game specification data, comprising:
displaying on a display an interactive form containing data entry fields for inputting game specification data that specifies characteristics of a video game developed for a particular game platform; and
entering game specification data into the data entry fields; and
validating the data entered into the data entry fields.

8. The method according to claim 7, further comprising:
executing in response to a user input a procedure to generate a CRC from a ROM image of the video game.

9. The method according to claim 7, further comprising:
executing in response to a user input a procedure to split a ROM image of the video game.

10. The method according to claim 7, further comprising:
executing in response to a user input a procedure to merge a file with a ROM image of the video game.

11. The method according to claim 7, further comprising:
executing in response to a user input a procedure to adjust the size of a ROM image of the video game.

12. A game submission system, comprising:
communication circuitry for receiving video games and video game specification data submitted thereto over a communications network;
a memory for storing routing information; and
processing circuitry for routing data regarding submitted video games and video game specification data in accordance with the routing data.

13. The game submission system according to claim 12, wherein the communications network is the Internet.

14. The game submission system according to claim 12, wherein the memory further stores status data regarding the status of submitted of video games and video game specification data, the status information being accessible to remote computer terminals.

15. The game submission system according to claim 12, wherein the data regarding submitted video games and video game specification data comprises a notification of receipt of the submitted video game and video game specification data.

16. The game submission system according to claim 12, wherein the data regarding submitted video games and video game specification data comprises the submitted video games and/or the video game specification data.
